(19) United States
(12) Patent Application Publication
(10) Pub. No.: US 2018/0265047 A1
(43) Pub. Date: Sep. 20, 2018

(54) VEHICULAR WASHER DEVICE

(71) Applicant: HONDA MOTOR CO., LTD., Tokyo (JP)

(72) Inventors: Takuro Hashimoto, Wako-shi (JP); Takeshi Sasaki, Wako-shi (JP)

(21) Appl. No.: 15/912,750

(22) Filed: Mar. 6, 2018

(30) Foreign Application Priority Data
Mar. 17, 2017 (JP) 2017-053630

(51) Int. Cl. B60S 1/48; B60S 1/52; B60S 1/50; F16K 15/02

(52) U.S. Cl. CPC B60S 1/487; F16K 15/026; B60S 1/50; B60S 1/52

(57) ABSTRACT

A vehicular washer device includes a tank that stores a washer fluid, a spray nozzle that sprays the washer fluid to a cleaning target, and a connection passage that connects the tank and the spray nozzles. A vortex tube that separates the washer fluid supplied from the tank into a hot fluid and a cold fluid and discharges the hot fluid toward the spray nozzles is interposed in the connection passage.

### CROSS-REFERENCE TO RELATED APPLICATION

This application claims priority based on Japanese Patent Application No. 2017-053630 filed Mar. 17, 2017, the contents of which are incorporated herein by reference.

### BACKGROUND OF THE INVENTION

### Field of the Invention

The present invention relates to a vehicular washer device that sprays a washer fluid to a cleaning target such as a windshield glass.

### Description of Related Art

As a vehicular washer device, a vehicular washer device that heats a washer fluid with an electric heater or heat of engine cooling water and sprays the heated washer fluid to a cleaning target is known (for example, see Japanese Utility Model Publication No. Sho 62-32930 and Japanese Unexamined Patent Application, First Publication No. Sho 58-53549).

### SUMMARY OF THE INVENTION

However, when the washer fluid is heated by the electric heater, power consumption of the vehicle by the electric heater increases.

Further, when the washer fluid is heated by the heat of the engine cooling water, cooling water piping of an engine becomes complicated, which is likely to cause an increase in manufacturing cost.

An aspect of the present invention provides a vehicular washer device capable of spraying heated washer fluid to a cleaning target without causing an increase in power consumption or complication of piping.

A vehicular washer device according to the present invention adopts the following configurations.

(1) A vehicular washer device according to the present invention includes a tank that stores a washer fluid; a spray nozzle that sprays the washer fluid to a cleaning target; and a connection passage that connects the tank and the spray nozzle, wherein a vortex tube that separates the washer fluid supplied from the tank into a hot fluid and a cold fluid and discharges the hot fluid toward the spray nozzle is interposed in the connection passage.

According to the aspect (1), when the washer fluid flows into the vortex tube in the connection passage, the washer fluid is separated into the hot fluid and the cold fluid inside the vortex tube, and the washer fluid of the separated hot fluid is discharged from the spray nozzle onto the cleaning target. In the case of this vehicular washer device, since a part of the washer fluid can be turned into a hot fluid in the vortex tube without using electric heating, power consumption of the vehicle can be suppressed. Further, complication of piping as in a case in which engine cooling water is used is not caused.

(2) In the aspect (1), a one-way valve that prevents backflow of the washer fluid from the spray nozzle side may be provided inside the vortex tube.

According to the aspect (2), since it is not necessary to provide the one-way outside valve separately from the vortex tube, the number of parts can be reduced and a structure of the connection passage can be simplified.

(3) In the aspect (1) or (2), the vortex tube includes a cylindrical main passage; a cold fluid discharge port provided at one end of the main passage; a hot fluid discharge port provided at the other end of the main passage; and an inflow port that is provided between one end and the other end of the main passage and causes the washer fluid supplied from the tank to flow into the main passage as a turning flow along an inner surface of the main passage, and the one-way valve may be provided between the inflow port and the hot fluid discharge port that are disposed inside the main passage.

According to the aspect (3), since a high temperature side flow and a low temperature side flow inside the main passage can be separated by using the one-way valve, a structure of the vortex tube can be simplified.

According to the aspect of the present invention, since the vortex tube is interposed in the connection passage connecting the tank and the spray nozzle, and the washer fluid turning into the hot fluid in the vortex tube is discharged toward the spray nozzle, it is possible to discharge the heated washer fluid to the cleaning target without causing an increase in power consumption and complication of piping.

### BRIEF DESCRIPTION OF THE DRAWINGS

FIG. 1 is a diagram illustrating a configuration of a vehicular washer device according to an embodiment of the present invention.

FIG. 2 is a longitudinal cross-sectional view of a vortex tube that is used in the vehicular washer device according to the embodiment of the present invention.

FIG. 3 is a vertical cross-sectional view illustrating a part of a vortex tube according to the embodiment of the present invention in detail.

FIG. 4 is a vertical cross-sectional view illustrating the part of the vortex tube according to the embodiment of the present invention in detail.

### DETAILED DESCRIPTION OF THE INVENTION

Hereinafter, an embodiment of the present invention will be described below with reference to the drawings.

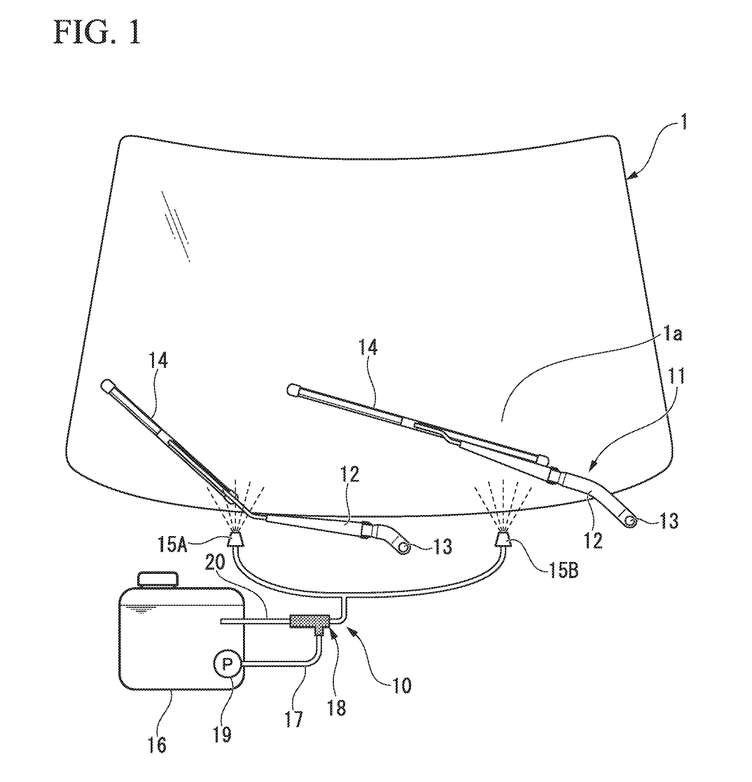

FIG. 1 is a front view of a portion of a windshield glass 1 on the front side of a vehicle that adopts a vehicular washer device 10 (hereinafter referred to as a “washer device 10”) according to an embodiment.

A pair of left and right wiper arms 12 of a wiper device 11 are installed at positions spaced to the left and right on a vehicle body panel under the windshield glass 1. A base portion of each wiper arm 12 is rotatably supported by a pivot shaft 13. A wiper blade 14 for wiping an outer surface 1a of the windshield glass 1 is held at an end portion of each wiper arm 12. In the embodiment, the windshield glass 1 is a cleaning target.

Further, a pair of left and right spray nozzles 15A and 15B of the washer device 10 are installed on the vehicle body panel under the windshield glass 1. The spray nozzles 15A and 15B are disposed at positions spaced to the left and right under the windshield glass 1 and sprays the washer fluid onto the outer surface 1a of the windshield glass 1.

The washer device 10 includes a tank 16 that stores the washer fluid, the pair of right and left spray nozzles 15A and 15B, and a connection passage 17 that connects the tank 16 and the left and right spray nozzles 15A and 15B. A vortex tube (a Ranque-Hirsch tube) 18 is interposed in the connection passage 17. A pump 19 that pumps the washer fluid in the tank 16 is provided in the tank 16, and an upstream side of the connection passage 17 is connected to the pump 19. Further, a return passage 20 for returning a surplus washer fluid discharged from the vortex tube 18 to the tank 16 is connected to the tank 16.

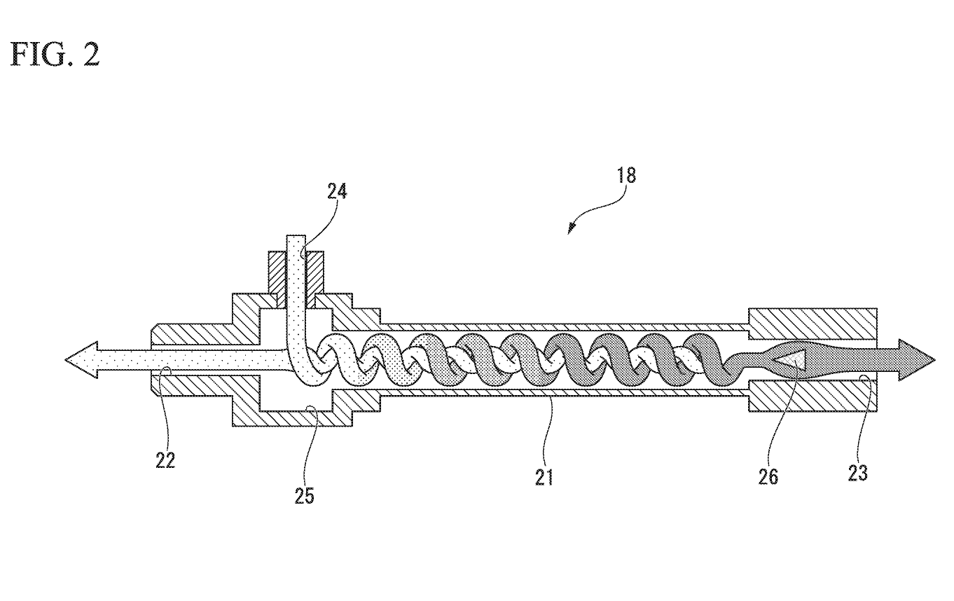

FIG. 2 is a view illustrating a schematic longitudinal section of the vortex tube 18.

The vortex tube 18 separates a fluid into a high temperature fluid and a low temperature fluid according to a vortex principle. In this embodiment, the vortex tube 18 separates the washer fluid discharged from the pump 19 into a hot fluid with a high temperature and a cold fluid with a low temperature, and discharges the hot fluid toward the spray nozzles 15A and 15B. Further, the cold fluid is returned to the tank 16 through the return passage 20.

The vortex tube 18 of the embodiment includes a cylindrical main passage 21, a cold fluid discharge port 22 provided at one end of the main passage 21, a hot fluid discharge port 23 provided at the other end of the main passage 21, and an inflow port 24 provided near the cold fluid discharge port 22 in the middle of the main passage 21. A one-way valve 26 that allows only a flow of the washer fluid to the hot fluid discharge port 23 is provided near the other end inside the main passage 21. The cold fluid discharge port 22 is connected to the return passage 20, and the hot fluid discharge port 23 is connected to the spray nozzle 15A and 15B sides of the connection passage 17. Further, the inflow port 24 is connected to the pump 19 side of the connection passage 17.

A turning chamber 25 is provided in a portion of the main passage 21 facing the inflow port 24 so that the washer fluid pressurized to a high pressure is introduced into a turning chamber 25 from the inflow port 24. The washer fluid introduced into the turning chamber 25 turns into a turning flow while being pressed by a centrifugal force against an inner wall of the main passage 21, and travels toward the hot fluid discharge port 23. Some of the washer fluid pushes and opens the one-way valve 26, and is discharged to the hot fluid discharge port 23.

In this case, a traveling direction of the remaining washer fluid that does not pass through the one-way valve 26 is reversed at the one-way valve 26, and the remaining washer fluid travels toward the cold fluid discharge port 22 while turning on the inner side of the turning flow directed to the hot fluid discharge port 23, and is discharged to the cold fluid discharge port 22. In this case, heat exchange is performed between a turning flow on the outer side directed to the hot fluid discharge port 23 and a turning flow on the inner side which is reversed at the one-way valve 26 and directed to the cold fluid discharge port 22. As a result, the washer fluid is discharged as the hot fluid from the hot fluid discharge port 23, and the washer fluid is discharged as the cold fluid from the cold fluid discharge port 22.

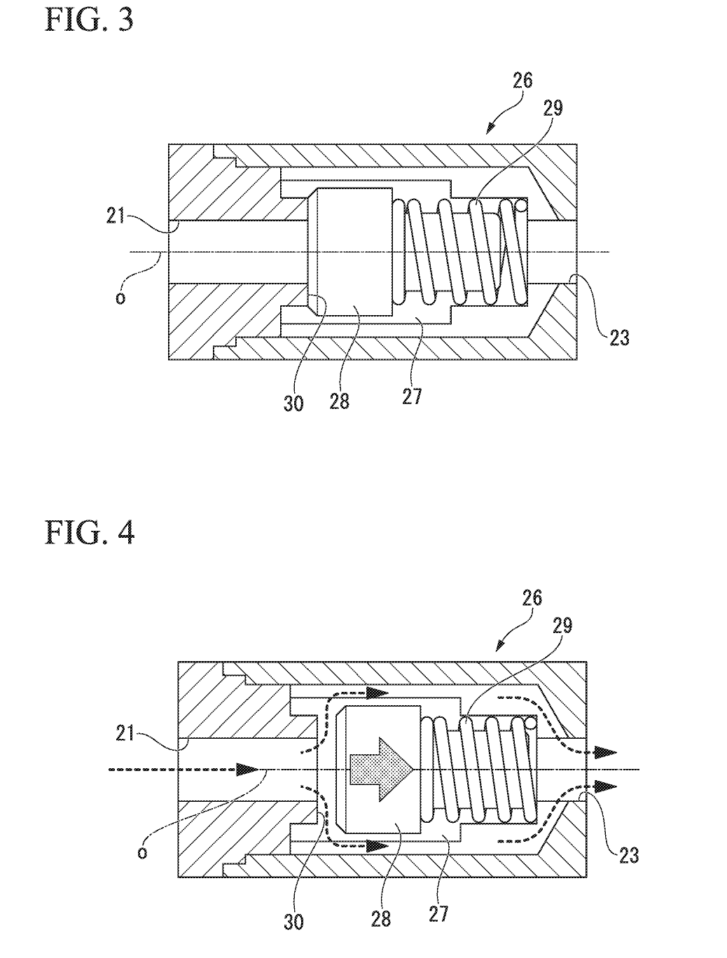

FIGS. 3 and 4 are cross-sectional views illustrating an installation portion of the one-way valve 26 of the vortex tube 18 in detail. FIG. 3 illustrates a state in which the one-way valve 26 is closed, and FIG. 4 illustrates a state in which the one-way valve 26 is opened.

A valve body accommodation chamber 27 is provided in a pipeline near the hot fluid discharge port 23 of the vortex tube 18. A valve body 28, and a biasing spring 29 that biases the valve body 28 in a valve closing direction are accommodated in the valve body accommodation chamber 27. An end portion of the main passage 21 facing the inside of the valve body accommodation chamber 27 serves as a valve seat 30 to which the valve body 28 abuts when the valve is closed. When a pressure in the main passage 21 is lower than a pre-set pressure, the valve body 28 closes the end portion of the main passage 21 due to a biasing force of the biasing spring 29. When the pressure in the main passage 21 increases to be equal to or higher than the pre-set pressure, the valve body 28 pushes and opens the end portion of the main passage 21 against the biasing force of the biasing spring 29.

The valve body 28 is disposed coaxially with an axis O of the main passage 21. As illustrated in FIG. 4, when the end portion of the main passage 21 has been opened, the washer fluid passes through an outer peripheral side thereof and is discharged to the hot fluid discharge port 23. Therefore, some of the turning flow on the outer side of the washer fluid traveling in the main passage 21 toward the hot fluid discharge port 23 is discharged to the hot fluid discharge port 23 through the outer side of the valve body 28, and the remaining washer fluid bounces from an end surface of the valve body 28, turns into a turning flow on the inner side, and travels to the cold fluid discharge port 22.

Because the washer device 10 according to the embodiment has the above-described configuration, when the pump 19 is operated by a switch operation or the like of a driver, the washer fluid turns into a turning flow at a high pressure from the inflow port 24 of the vortex tube 18, flows into the main passage 21, and travels toward the hot fluid discharge port 23.

In this case, the one-way valve 26 is opened, and some of the washer fluid turns into a hot fluid and is discharged from the hot fluid discharge port 23 to the spray nozzles 15A and 15B. Further, in this case, the remaining washer fluid that bounces at the valve body 28 of the one-way valve 26 turns into the turning flow on the inner side, turns into a cold fluid, and is discharged from the cold fluid discharge port 22 to the return passage 20. Accordingly, the hot washer fluid is sprayed from the spray nozzles 15A and 15B to the outer surface 1a of the windshield glass 1, and the cold washer fluid is returned to the tank 16. Accordingly, ice or dirt adhered to the windshield glass 1 is removed by the hot washer fluid.

As described above, the washer device 10 according to the embodiment has a structure in which the vortex tube 18 is interposed in the connection passage 17 connecting the tank 16 and the spray nozzles 15A and 15B, and the washer fluid turning into the hot fluid in the vortex tube 18 is discharged toward the spray nozzles 15A and 15B. Thus, it is possible to spray the heated washer fluid onto the outer surface 1a of the windshield glass 1 without causing an increase in power consumption or complication of piping.

Further, in the washer device 10 according to the embodiment, the one-way valve 26 for preventing backflow of the washer fluid at the spray nozzles 15A and 15B is assembled inside the vortex tube 18. Therefore, it is not necessary to provide a one-way valve separately from the vortex tube 18 on the connection passage 17. Accordingly, when this configuration is adopted, the number of parts can be reduced and a structure of the connection passage 17 can be simplified.

Further, in the washer device 10 according to the embodiment, the vortex tube 18 includes the cylindrical main passage 21, the cold fluid discharge port 22 provided at one end of the main passage 21, the hot fluid discharge port 23 provided at the other end of the main passage 21, and the inflow port 24 that causes the washer fluid to flow into the main passage 21 as the turning flow along the inner surface. The one-way valve 26 is provided between the inflow port 24 and the hot fluid discharge port 23 that are provided inside the main passage 21. Therefore, it is possible to separate a flow on the high temperature side of the washer fluid and a flow on the low temperature side inside the main passage 21 by using the one-way valve 26 assembled inside the vortex tube 18. Therefore, when this configuration is adopted, the structure of the vortex tube 18 can be simplified.

Note that the present invention is not limited to the above-described embodiment, and various design changes can be performed without departing from the scope of the present invention. For example, although the windshield glass 1 on the front side is the cleaning target in the above embodiment, the cleaning target may be a glass or a resin member other than the windshield glass 1 on the front side.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicular washer device comprising:
a tank that stores a washer fluid;
a spray nozzle that sprays the washer fluid to a cleaning target; and
a connection passage that connects the tank and the spray nozzle,
wherein a vortex tube that separates the washer fluid supplied from the tank into a hot fluid and a cold fluid and discharges the hot fluid toward the spray nozzle is interposed in the connection passage.

2. The vehicular washer device according to claim 1,
wherein a one-way valve that prevents backflow of the washer fluid from the spray nozzle side is provided inside the vortex tube.

3. The vehicular washer device according to claim 2,
wherein the vortex tube includes
a cylindrical main passage;
a cold fluid discharge port provided at one end of the main passage;
a hot fluid discharge port provided at the other end of the main passage; and
an inflow port that is provided between one end and the other end of the main passage and causes the washer fluid supplied from the tank to flow into the main passage as a turning flow along an inner surface of the main passage, and
the one-way valve is provided between the inflow port and the hot fluid discharge port that are disposed inside the main passage.
